(19) United States
(12) Patent Application Publication
(10) Pub. No.: US 2008/0204815 A1
(43) Pub. Date: Aug. 28, 2008

(54) IMAGE FORMING APPARATUS, SEGRAGATION METHOD IN IMAGE FORMING APPARATUS

(75) Inventors: Yuji Kazama, Mishima-shi (JP); Katsunori Suzuki, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/677,767

(22) Filed: Feb. 22, 2007

(51) Int. Cl. H04N 1/00

(52) U.S. Cl. 358/401

(57) ABSTRACT

An image forming apparatus has a reading unit configured to read image information on a sheet, and a segregating unit configured to detect an identifier image from the image information read by the reading unit and to segregate plural applications of the sheet on the basis of the identifier image.

### BACKGROUND OF THE INVENTION

Recently, as the performance of image forming apparatuses such as digital copy machines has improved, integrated digital devices having not only a copying function but also a printer function have been developed and broadly used. As a secondary function of such an image forming apparatus, a technique of using a reusable paper has been known.

In Patent Reference 1 (JP-A-2000-255909), both sides of a sheet are scanned to distinguish a used side and an unused side, the sheet is then reversed and so on, and a reusable paper is carried to a tray, thus realizing the reuse. That is, when one side is scanned and it is found used, the sheet is reversed and scanned again to determine whether it has been used or not. Thus, it is possible to reuse a sheet having at least one blank side for copying or the like.

However, in this Patent Reference 1, since there are cases where both sides of a sheet must be scanned in order to determine the reuse of the sheet, there is a problem that the determining time and processing causes a burden.

### BRIEF SUMMARY OF THE INVENTION

An embodiment of an image forming apparatus according to the invention is an image forming apparatus comprising:

a reading unit (125) configured to read image information on a sheet; and

a segregating unit (124) configured to detect an identifier image from the image information read by the reading unit and to segregate plural applications of the sheet on the basis of the identifier image.

### BRIEF DESCRIPTION OF THE SEVERAL VIEWS OF THE DRAWINGS

FIG. 1 is a structural view to explain an exemplary mechanical structure of an image forming apparatus according to the invention.

FIG. 2 is a block diagram to explain an exemplary electrical configuration of the image forming apparatus according to the invention.

FIG. 3 is an explanatory view to explain an exemplary meaning of a bar code used by the image forming apparatus according to the invention.

FIG. 4 is an explanatory view to explain another exemplary meaning of a bar code used by the image forming apparatus according to the invention.

FIG. 5 is an explanatory view showing an exemplary relation between a bar code used by the image forming apparatus according to the invention and a carrying destination.

FIG. 6 is a flowchart showing an example of discharge paper segregation processing of a bar code in the image forming apparatus according to the invention.

### DETAILED DESCRIPTION OF THE INVENTION

Hereinafter, discharge paper segregation processing in an image forming apparatus according to an embodiment of the invention will be described in detail with reference to the drawings.

### Image Forming Apparatus According to the Invention

### Mechanical Configuration

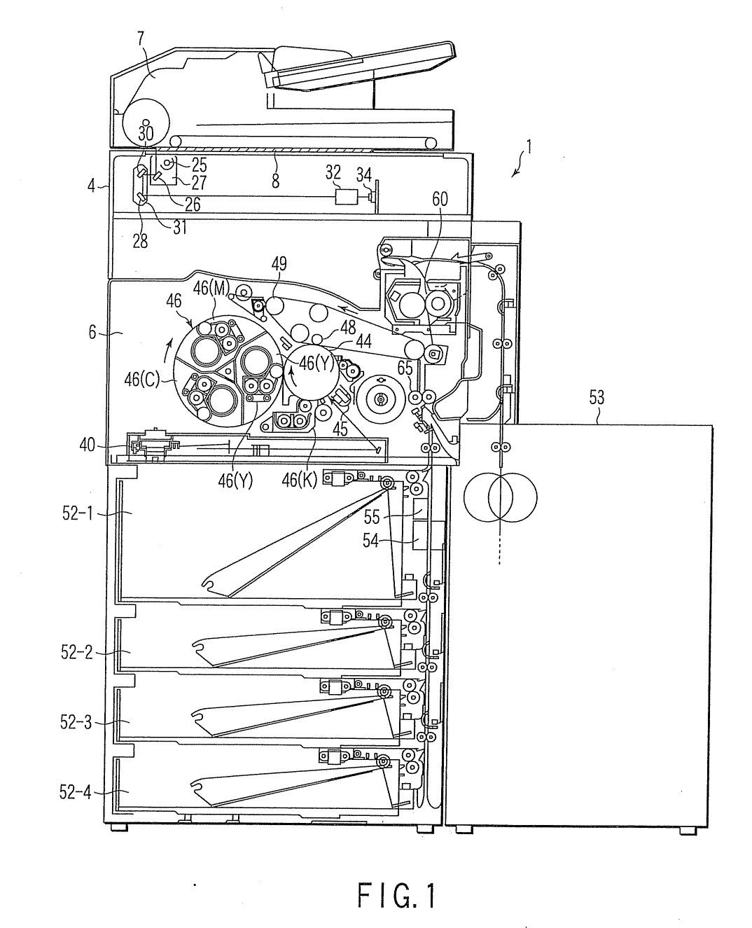

First, an exemplary configuration of an image forming apparatus according to the invention will be described. FIG. 1 is a structural view to explain the internal structure of the image forming apparatus. This image forming apparatus 1 includes a color scanner unit 4 as an image reading unit, a printer unit 6, an automatic document feeder (hereinafter referred to simply as ADF) 7, a shredder unit 53, an operation panel 80 and so on.

The scanner unit 4 has the ADF 7 situated above it, and has an original setting table 8 made of a transparent glass which is arranged to face the ADF 7 in its closed state and on which an original is to be set. Below the original setting table 8, an exposure lamp 25 that illuminates an original set on the original setting table 8, and a first mirror 26 that condenses light from the exposure lamp 25 onto the original and deflects reflected light from the original, for example, leftward with respect to the drawing, are fixed to a first carriage 27.

The first carriage 27 is arranged to be movable parallel to the original setting table 8. It is reciprocated below the original setting table 8 by a scanning motor, not shown, via a toothed belt or the like, not shown.

Also, a second carriage 28 that is movable parallel to the original setting table 8 is arranged below the original setting table 8. Second and third mirrors 30, 31 that sequentially deflect the reflected light from the original, which is deflected by the first mirror 26, are attached to the second carriage 28 at right angles to each other. The second carriage 28 is caused to follow the first carriage 27 by the toothed belt or the like that drives the first carriage 27, and is moved in parallel along the original setting table 8 at a half speed of the first carriage 27.

Also, an image forming lens 32 that converges the reflected light from the third mirror 31 on the second carriage 28, and a CCD (photoelectric converter) 34 that receives and photoelectrically converts the reflected light converged by the image forming lens, are arranged below the original setting table 8. The image forming lens 32 is arranged movably via a driving mechanism, within a plane including the optical axis of the light deflected by the third mirror 31, and the image forming lens itself moves to form an image with the reflected light at a desired magnification. The CCD 34 photoelectrically converts the incident reflected light and outputs an electric signal corresponding to the read original.

Meanwhile, the printer unit 6 has a laser exposure device 40 that functions as latent image forming means. The laser exposure device 40 has a semiconductor laser as a light source, a polygon mirror as a scanning member that continuously deflects a laser beam emitted from the semiconductor laser, a polygon motor as a scanning motor that rotationally drives the polygon mirror at a predetermined number of rotations, and an optical system that deflects the laser beam from the polygon mirror and guides it to a photoconductive drum 44, which will be described later.

The printer unit 6 also has the photoconductive drum 44 that is rotatable as an image carrier arranged substantially at the center of the apparatus body. The circumferential surface of the photoconductive drum 44 is exposed to the laser beam from the laser exposure device 40 and a desired electrostatic latent image is formed thereon. A charger 45 that charges the circumferential surface of the drum with predetermined electric charges, a developing unit 46 that supplies toner as a developer to the electrostatic latent image formed on the circumferential surface of the photoconductive drum 44 and develops it at a desired image density, and a transfer charger 48 that transfers the toner image formed on the photoconductive drum 44 to a paper, are arranged around the photoconductive drum 44.

In the lower part of the apparatus body, a paper feed cassette 52-1, a segregation cassette 52-2, a reuse tray 52-3 and a disposal tray 52-4, each of which can be pulled out from the apparatus body, are arranged in a stacked state with respect to each other.

As an example, a bar code reader unit 55, which is a reading unit for bar code detection, is provided at a rear part of the paper feed cassette 52-1. However, it may be arranged anywhere as long as it can read out a bar code that is an identifier on the surface of a paper from the segregation cassette 52-2. Also, an original reading head 54 for one side or both sides is arranged near the bar code reader unit 55, as shown in FIG. 1. It detects image information to determine whether at least one side of an original is blank or not.

Also, the shredder unit 53 is provided by the side of the image forming apparatus 10 in such a manner that the shredder unit is controllable by a shredder control unit 125 controlled by a discharge paper segregating unit 124, a main CPU 91 and the like, which will be described later. Here, a paper carrier path is provided at least from the segregation cassette 52-2 to the shredder unit 53, and highly confidential papers can be shredded when it is necessary.

A pair of resist rollers 65 is provided upstream of the photoconductive drum 44. The pair of resist rollers 65 corrects the inclination of a copy paper that is taken out, aligns the edge of a toner image on the photoconductive drum 44 with the edge of the copy paper, and feeds the copy paper to a transfer belt unit 49 at the same speed as the moving speed of the circumferential surface of the photoconductive drum 44.

Also, the operation panel 80 to input various copy conditions and a copy start signal that starts a copy operation is provided at the top of the front part of the apparatus body. The operation panel 80 includes a print key 82, a panel CPU 83, and a liquid crystal display unit 84, for example, as shown in FIG. 1. The print key 82 is to instruct the start of copying. The liquid crystal display unit 84 is to display the number of original sheets and the number of copy sheets, and to display the copy magnification and editing, and provide various kinds of operation guidance. A touch panel is provided in this liquid crystal display unit 84.

### Electrical Configuration

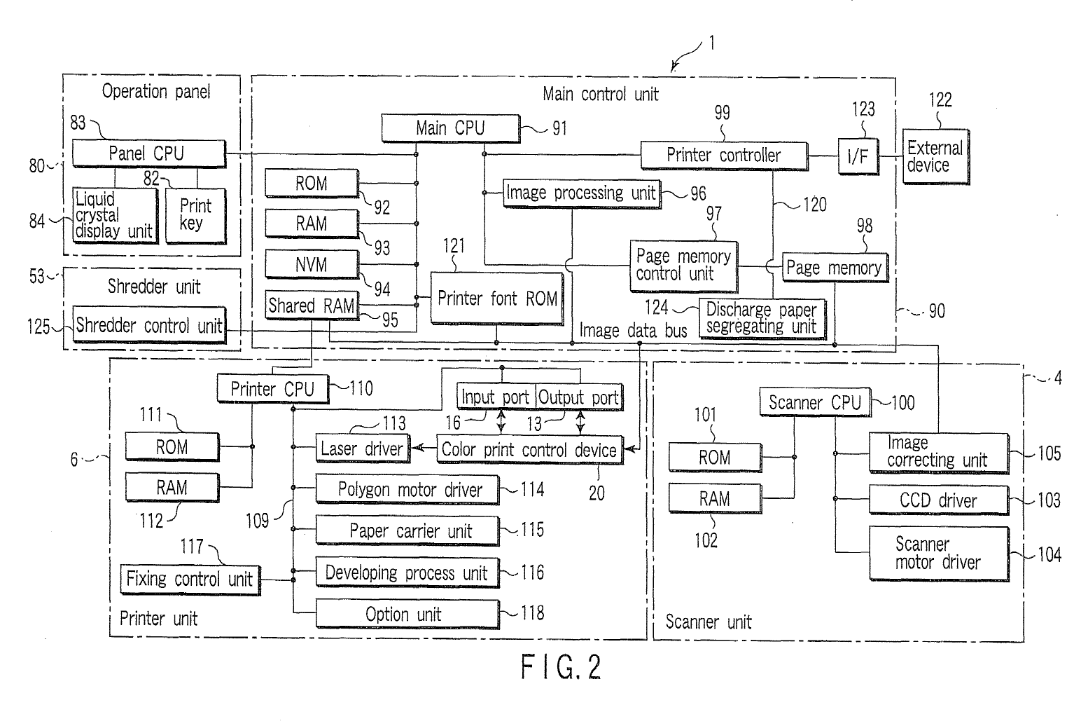

In the block diagram shown in FIG. 2, the image forming apparatus according to the invention has a control unit including three CPUs, that is, a main CPU (central processing unit) 91 in a main control unit 90, a scanner CPU 100 of the color scanner unit 4, and a printer CPU 110 of the color printer unit 6. The main CPU 91 performs serial communication with the printer CPU 110 and outputs an operation instruction thereto. The printer CPU 110 sends back a status. Also, the main CPU 91 performs serial communication with the scanner CPU 100 and outputs an operation instruction thereto. The scanner CPU 100 sends a status back to the main CPU 91.

The operation panel 80 is connected with the main CPU 91. The main control unit 90 also has the main CPU 91, a ROM 92, a RAM 93, a NVM 94, an image processing unit 96 that performs expansion, compression and conversion processing, a page memory control unit 97, a page memory 98, and a printer controller 99.

The main CPU 91 is to control the entirety of the main control unit 90. Control programs are stored in the ROM 92. The RAM 93 is to temporarily store data.

The NVM (non-volatile random access memory or non-volatile RAM) 94 is a non-volatile memory backed up by a battery (not shown) and the data on the NVM 94 is held when power is turned off.

The page memory control unit 97 is to store image data to and read it from the page memory 98. The page memory 98 has an area where image data corresponding to plural pages can be stored, and it is formed to be capable of storing compressed data of the image data from the scanner unit 4, by each page. Font data corresponding to print data is stored in a printer font ROM 121.

The printer controller 99 includes the printer font ROM 121 and is to develop print data from an external device 200 such as a personal computer into image data by using the font data stored in the printer font ROM 121 with a resolution corresponding to the data indicating the resolution provided to the print data via an input port 16. Moreover, an external interface 123 is to communicate various signals to and from the external device 200. Also, image information or the like is acquired as facsimile data by a facsimile unit 85 and is saved in the page memory 98 or the like.

The scanner unit 4 includes the scanner CPU 100 that controls the entirety of the scanner unit 4, a ROM 101 in which control programs are stored, a RAM 102 for data storage, a CCD driver 103 that drives the CCD sensor 34, a scanner motor driver 104 that controls the rotation of the motor to move the exposure lamp 25 and the mirrors 26, 30, 31 and so on, and an image correcting unit 105 that includes a shading correction circuit configured to correct the difference between an A-D converter circuit that converts an analog signal from the CCD sensor 34 to a digital signal and the CCD sensor 34, or the variance in threshold level to an output signal from the CCD sensor 34 due to a change in the ambient temperature, and a line memory to temporarily store the shading-corrected digital signal from the shading correction circuit.

The printer unit 6 includes the printer CPU 110 that controls the entirety of the printer unit 6, a ROM 111 in which control programs are stored, a RAM 112 for data storage, a laser driver 113 that turns on and off light emission (exposure) by a semiconductor laser, a polygon motor driver (motor controller) 114 that controls the rotation of the polygon motor of the laser unit, a paper carrier unit 115 that controls the transport of a sheet through a carrier path, a developing process unit 116 that carries out charging, development and transfer by using the charger 45, the developing unit 46 and the transfer charger 48, a fixing control unit 117 that controls a fixer unit 60, an option unit 118, an output port 13, the input port 16, and an image forming apparatus 20 as an embodiment of the invention.

Also, the image processing unit 96 that performs expansion, compression and conversion processing and the page memory 98 are connected with each other in order to send and receive image data. The image correcting unit 105 and the image processing unit 96 are connected with each other in order to send and receive image data. Similarly, the image correcting unit 105 and the color print control device 20 are connected with each other in order to send and receive image data. Similarly, the printer controller 99 and the image processing unit 96 are connected with each other in order to send and receive image data.

Also, the discharge paper segregating unit 124, which performs discharge paper segregation processing of sheets for segregation stored in the segregation cassette 52-2 mainly in accordance with an image signal from the bar code reader unit 55, is connected with the main CPU 91 via the printer controller 99.

### Discharge Paper Segregation Processing as One Embodiment of the Invention

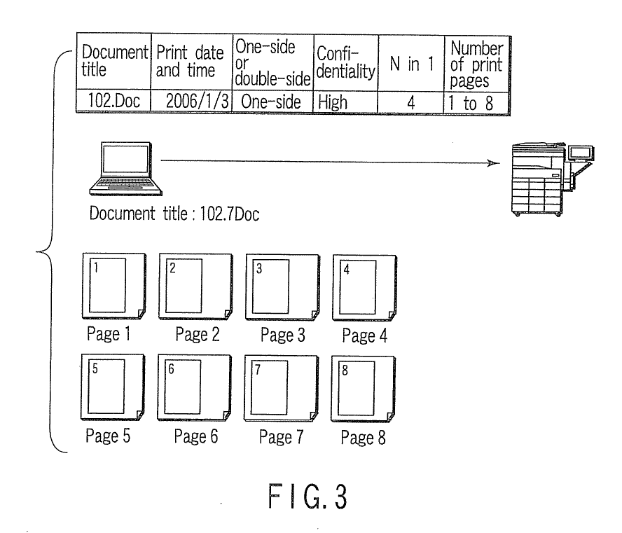

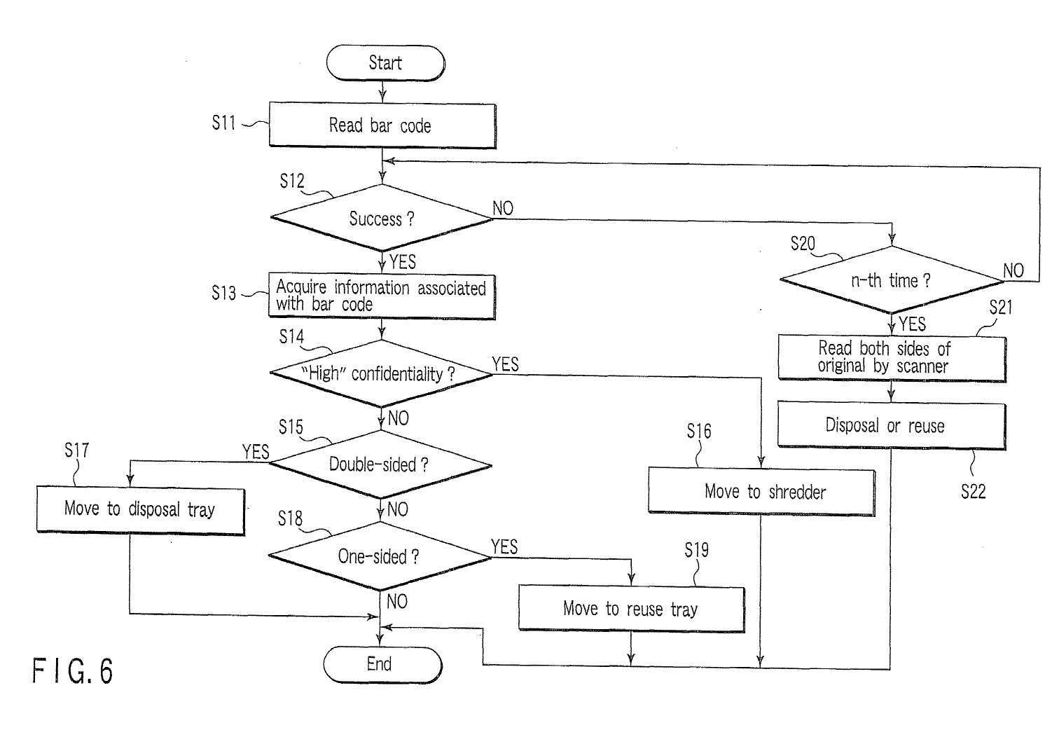

Next, the discharge paper segregation processing in the image forming apparatus as an embodiment of the invention will be described in detail with reference to the explanatory views of FIG. 3 to FIG. 5 and the flowchart of FIG. 6.

First, the sheets for segregation stored in the segregation cassette 52-2 of the image forming apparatus 1 are carried under the control of the paper carrier unit 115 in accordance with the operation on the operation panel 80 or the like, and a bar code image is read by the bar code reader 55 (step S11).

If the discharge paper segregating unit 124 or the like determines that the bar code is successfully read (step S12), the discharge paper segregating unit 124 analyzes the image of the bar code and acquires the information indicated by the bar code image (step S13).

Here, the bar code is an exemplary identifier written at a predetermined position on a sheet. It does not necessarily have to be a bar code and can be anything that can be written on a sheet and provides readable information. That is, as an example, a bar code is issued and printed on one side of a sheet as one unit on the basis of print instruction information of a document creation application, printer driver or the like when the image forming apparatus carries out printing via an external PC or the like.

For example, FIG. 3 shows an example of print instruction information of a document from a PC. In this example of print instruction information, the document designated for printing from the PC has information of document title: 102.Doc, print date and time: Jan. 3, 2006 sheet: one-side printing, confidentiality: “high”, 4 in 1, and printing of pages 1 to 8.

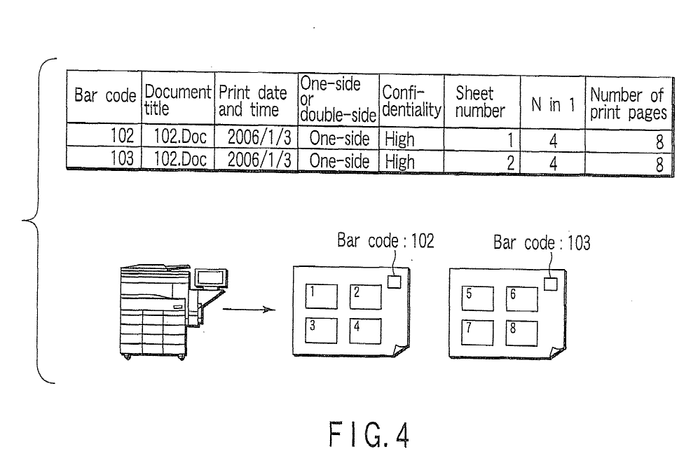

The image forming apparatus receives the above print instruction information and actually prints the image information on sheets. In this case, since the number of pages of 8, 4 in 1, and one-side printing are designated, the image information is to be printed on two sheets. As shown in FIG. 4, two bar codes 102 and 103 associated with the print instruction are generated and printed at a predetermined position on the sheets.

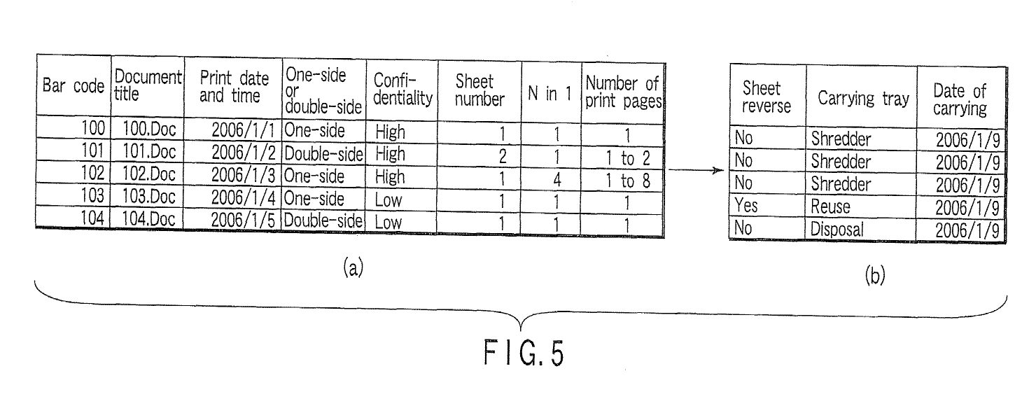

The first print sheet has a “sheet number” of “1” and the second print sheet has a “sheet number” of “2”, as shown in FIG. 4. As described above, print instruction information (a) associated with bar codes in FIG. 5 is managed, for example, by the discharge paper segregating unit 124 or the like in the image forming apparatus 1.

The sheets on which bar codes are thus printed are stored, for example, in the segregation cassette 52-2, and the bar codes are read in order by the bar code reader unit 55 under the control of the main CPU 91 and the discharge paper segregating unit 124 in accordance with the operation on the operation panel 80 or the like (turning on a discharge paper processing switch or the like).

That is, instead of determining the presence or absence of an image on a reuse sheet in reuse determination processing, the bar code is read to determine whether the sheet is a confidential document or not, or whether the sheet is double-sided or not, on the basis of the print instruction information (a) of FIG. 5 stored in the discharge paper segregating unit 124 or the like in the image forming apparatus 1. Thus, the result of determination (b) is provided.

In short, since documents 100.Doc, 101.Doc, and 102.Doc have “high” confidentiality (step S14), they are carried to the shredder unit 53 (step S16).

A document 103.Doc has “low” confidentiality (step S14) and is of one-side printing (step S15). Therefore, it is carried to the reuse tray (step S19).

A document 104.Doc has “low” confidentiality and is of double-side printing (step S15). Therefore, it is carried to the disposal tray (step S17).

Also, if the date when the sheet was carried is left as a log, of course, it is possible to browse when the confidential document was processed.

Moreover, if the reading by the bar code reader 55 fails in step S12 and the reading is made for the n-th time (step S20), both sides of the original are read by the original reading head 54 under the control of the discharge paper segregating unit 124 or the like (step S21). Then, in accordance with the result of reading, the sheet is moved to the disposal tray 52-4 or the reuse tray 52-3 (step S22).

As described above in detail, in the image forming apparatus according to an embodiment of the invention, since the confidentiality of a sheet is checked with the identifier of the sheet (information proper to the sheet), it is possible to trace when the confidential document was generated and when it was disposed of. Thus, it can be securely determined whether a sheet should be disposed of or not, and it is possible to reuse resources while protecting confidential information.

Also, as the used side of a sheet is determined from the identifier (bar code), it is not always necessary to scan both sides of a sheet and quick processing can be realized.

With the above-described various embodiments, those skilled in the art can realize the present invention. However, those skilled in the art can easily think of various modifications of these embodiments and can apply various embodiments without having inventive abilities. Therefore, the present invention applies to a broad range without departing from the disclosed principles and novel features, and should not be limited to the above embodiments.

What is claimed is:

1. An image forming apparatus comprising:
a reading unit configured to read image information on a sheet; and
a segregating unit configured to detect an identifier image from the image information read by the reading unit and to segregate plural applications of the sheet on the basis of the identifier image.

2. An image forming apparatus according to claim 1, further comprising:
plural trays configured to store a sheet; and
a carrier unit configured to carry the sheet to the reading unit and to carry the sheet from the reading unit to the plural trays;
wherein the segregating unit controls the carrier unit in order to carry the sheet from the carrier unit to one of the plural trays in accordance with a result of segregation of the sheet.

3. An image forming apparatus according to claim 1, wherein the identifier is a bar code.

4. An image forming apparatus according to claim 1, wherein the segregating unit performs control in order to carry the sheet to one of plural trays on the basis of information about one-side use or double-side use indicated by the identifier.

5. An image forming apparatus according to claim 1, wherein the segregating unit performs control in order to carry the sheet to one of plural trays on the basis of confidentiality indicated by the identifier.

6. An image forming apparatus according to claim 1, wherein when it is meant that confidentiality indicated by the identifier is high, the segregating unit carries the sheet to a shredder tray, and when it is meant that confidentiality indicated by the identifier is low and the sheet is of one-side use, the segregating unit carries the sheet to a reuse tray, and when it is meant that confidentiality indicated by the identifier is low and the sheet is of double-side use, the segregating unit carries the sheet to a disposal tray.

7. An image forming apparatus according to claim 1, wherein when the segregating unit cannot detect the identifier from the image information, the control unit controls the carrier unit and reads both sides of the sheet image by the reading unit, and determines whether both sides of the sheet have been used, and performs control so that the sheet will be reused if one side has been used, whereas the sheet will be disposed of if both sides have been used.

8. A segregation method in an image forming apparatus comprising:
reading image information on a sheet;
detecting an identifier image from the read image information; and
segregating plural applications of the sheet on the basis of the detected identifier image.

9. The segregation method according to claim 8, wherein control is made in order to carry the sheet to one of plural trays in accordance with a result of segregation of the sheet.

10. The segregation method according to claim 8, wherein the identifier is a bar code.

11. The segregation method according to claim 8, wherein control is made in order to carry the sheet to one of plural trays on the basis of information about one-side use or double-side use indicated by the identifier.

12. The segregation method according to claim 8, wherein control is made in order to carry the sheet to one of plural trays on the basis of confidentiality indicated by the identifier.

13. The segregation method according to claim 8, wherein when it is meant that confidentiality indicated by the identifier is high, the sheet is carried to a shredder tray, and when it is meant that confidentiality indicated by the identifier is low and the sheet is of one-side use, the sheet is carried to a reuse tray, and when it is meant that confidentiality indicated by the identifier is low and the sheet is of double-side use, the sheet is carried to a disposal tray.

14. The segregation method according to claim 8, wherein when the identifier cannot be detected from the image information, both sides of the sheet image are read, and whether both sides of the sheet have been used is determined, and control is made so that the sheet will be reused if one side has been used, whereas the sheet will be disposed of if both sides have been used.

15. An image forming apparatus comprising:
reading means for reading image information on a sheet; and
segregation means for detecting an identifier image from the image information read by the reading means and segregating plural applications of the sheet on the basis of the identifier image.

16. An image forming apparatus according to claim 15, further comprising:
plural storage means for storing a sheet; and
carrier means for carrying the sheet to the reading means and carrying the sheet from the reading means to the plural storage means;
wherein the segregation means controls the carrier means in order to carry the sheet from the carrier means to one of plural trays in accordance with a result of segregation of the sheet.

17. An image forming apparatus according to claim 15, wherein the identifier is a bar code.

18. An image forming apparatus according to claim 15, wherein the segregating means performs control in order to carry the sheet to one of plural trays on the basis of information about one-side use or double-side use indicated by the identifier.

19. An image forming apparatus according to claim 15, wherein the segregation means performs control in order to carry the sheet to one of plural trays on the basis of confidentiality indicated by the identifier.
